(19) United States
(12) Patent Application Publication
(10) Pub. No.: US 2006/0263578 A1
(43) Pub. Date: Nov. 23, 2006

(54) Structural laminate

(76) Inventor: Robert Bordener, Bloomfield Hills, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/417,731

(22) Filed: May 4, 2006

Related U.S. Application Data
(60) Provisional application No. 60/677,782, filed on May 4, 2005.

(51) Int. Cl. B32B 3/00

(52) U.S. Cl. 428/172

(57) ABSTRACT

A process for forming a thermoplastic sheet layer containing granular particulate includes raising the temperature of a thermoplastic to form a melt At least 2% by weight of the particles making up the particulate have a mean x-y-z dimension average linear dimension greater than 0.008 inches. Upon cooling the pigmented melt, pellets are formed. The pellets are then melted and extruded to form a thermoplastic sheet layer. A structural laminate is also provided that has a thickness of from 0.015 to 0.35 inches and an overall composition of at least 60 total weight percent plastic resin. Of the 60 total weight plastic resin, at least 10 weight percent is thermoplastic. The resultant structural laminate has a coefficient of linear thermal expansion of less than 7×10⁻⁵ per degrees Celsius, a flexural modulus of between 250,000 and 900,000 pounds per square inch, and a heat distortion temperature of at least 170° F.

### RELATED APPLICATION

This application claims priority of U.S. Provisional Patent Application Ser. No. 60/677,782 filed May 4, 2005, which is incorporated herein by reference.

### FIELD OF THE INVENTION

The present invention in general relates to surface finish laminates and in particular to lightweight structural laminates with enhanced visual effects and processes for making the same.

### BACKGROUND OF THE INVENTION

Solid surface structures have become commonplace since the introduction of such surfaces by DuPont in the 1960s. Such surfaces are typically composed of polygonal granules of thermoset resin containing colorants and inorganic mineral fillers with the granules suspended in translucent thermoset resins. Such structures afford a simulation of stone for countertops with the added advantage of being castable into custom shapes thereby limiting the appearance of seams. However, the mass density and thickness of such structures creates the storage and handling inefficiencies that greatly increase the cost of installing such structures.

Attempts to address these limitations have focused on the production of a surface veneer simulative of stone or corresponding thickness thermoset structures. U.S. Pat. No. 5,628,949 is representative of veneer formation. However, previous attempts to form veneers generally failed to provide a perception of depth to the material beyond the actual veneer thickness.

Sheeting materials have also been constructed by embedding colored plastic particles into an otherwise clear polymer matrix. U.S. Pat. No. 6,749,932 is representative of the art. However, the visual perception of depth and the reflectivity associated with colored plastics is limited. Furthermore, the rigidity of such an article is only controlled by varying the sheet thickness.

Alternatively, it has long been appreciated that many of the problems associated with handling and shipping of thermoset structures relate to the inability to efficiently package structural components associated with particular projects such as a vanity countertop. As other industries have shown, reducing weight and providing systematic packaging decreases both breakage and transportation costs.

Further, the appearance of such materials has all depended upon the actual depth and thickness dimension of the materials themselves; therefore, there has been no development of a leveraged or multiplied appearance or optical technology in prior art materials.

Thus, there exists a need for a structural laminate affording a perception of thickness greater than that of the actual laminate. Additionally, the art would benefit from a more efficient packaging scheme for laminate structures.

There is also a long-felt need for improved building panels for interior and exterior applications, particularly in high-moisture areas, such as prefabricated tile boards and interior and exterior foundation trim.

### SUMMARY OF THE INVENTION

A process for forming a thermoplastic sheet layer containing granular particulate includes raising the temperature of a thermoplastic to form a melt and passing the melt through the mouth of a screw-and-barrel assembly. The melt is loaded with granular particulate to a level where a 0.90 inch thick melt is traversed by contacting at least one particle of the particulate. At least 2% by weight of the particles making up the particulate have a mean x-y-z dimension average linear dimension greater than 0.008 inches. The resultant melt is pigmented. Upon cooling the pigmented melt, pellets are formed. The pellets are then melted and extruded to form a thermoplastic sheet layer.

A structural laminate is provided that includes a photograph image backing to a transparent or translucent layer and subsequently bonding the transparent or translucent layer to at least one additional layer to yield a structural laminate.

A structural laminate is also provided that has a thickness of from 0.015 to 0.35 inches and an overall composition of at least 60 total weight percent plastic resin. Of the 60 total weight plastic resin, at least 10 weight percent is thermoplastic. The resultant structural laminate has a coefficient of linear thermal expansion of less than 7×10⁻⁵ per degrees Celsius, a flexural modulus of between 250,000 and 900,000 pounds per square inch, and a heat distortion temperature of at least 170° F. At least one strata layer of the structural laminate is inclusive of granular particulate, the granular particulate formed from a material having a coefficient of linear thermal expansion that is less than that of the plastic resin in a pure cured state independent of particulate.

A thermoplastic strata layer in the form of a structural laminate is provided that has at least 40% by weight thermoplastic resin and granules including at least 10% by weight of mineral within the resin. The granules have a size distribution in which the largest 10 number percent of the granules are less than 6 millimeters in mean x-y-z averaged linear dimension. The thermoplastic strata layer has a thickness of between 0.015 and 0.35 inches.

### BRIEF DESCRIPTION OF THE DRAWINGS

FIG. 1A is a schematic block diagram illustrating the steps in forming an inventive structural laminate, the laminate depicted in FIG. 1B in cross-sectional view;

FIG. 2A is a schematic block diagram detailing the steps in forming an inventive structural laminate having a modified coefficient of linear thermal expansion and affording a perception of greater depth to the laminate than thickness thereof, the laminate depicted in FIG. 2B in cross-sectional view;

FIG. 3 is an exploded cutaway view of the components of an inventive edging system;

FIG. 4 is a schematic block diagram illustrating the steps of forming an alternate embodiment of an inventive structural laminate;

FIG. 5 depicts exemplary top views of opaque backing layers for an inventive structural laminate; and

FIG. 6 is an exploded view of a ready to assemble vanity top kit.

### DETAILED DESCRIPTION OF THE INVENTION

The present invention has utility in the construction and use of structural laminates. It is appreciated that an inventive structural laminate is operative in a variety of use settings illustratively including architectural accoutrements such as, but not limited to, exterior building trim, countertops, roof shingles, building siding, faux tile boards, faux marble and granite boards, doors and cabinet trim, wallboard, flooring, and transportation. Additionally, an inventive structural laminate is readily bonded prior to, or subsequent to, installation to substances illustratively including glass fiber insulation, polymeric foam, wood, fiber cement, concrete, extruded plastic panels, foam plastic sheeting, particleboard, plywood, metal, fiber board, and glass. Additionally, it is appreciated that an inventive structural laminate is thermoformed around a core of plastic, polymeric or cellulosic material to create complex shapes, appliance fronts and cabinet components and simulated patterns of stone, as are commonly used in fireplace, basement and foundational trim settings and tile, as are commonly used in bathroom or kitchen settings.

An inventive panel is optionally formed by methods including the extrusion or injection of a decorative veneer of substantially thermoplastic resin and planarly bonding the veneer to either a sheet of foamed plastic, or an extruded sheet of high-void polymer-based material. The edges optionally have receiving channels for pre-molded trim pieces that fit along the edges to create finished panel edges where they are exposed to view. An inventive panel is alternatively formed by thermoforming a veneer to a substantially planar shape with curved edges to create a “hollow” panel, that when positioned against a wall or other substantially flat surface appears to have a thickness of about 0.375 to 0.5 inches. This hollow back is then filled with foam, such as a pre-made scrim or via injection molding. The surface of the panel is optionally embossed or cut or scored to simulate a tile or stone pattern. So that the pattern and any color variegated appearance match up correspondingly a special embossing process may be used, a veneer panel may be made with a clear or opaque outer panel, and an underlying strata layer of a visually differentiable color. As the panel is embossed the first layer is displaced, exposing color of the secondary layer, which may be colored to simulate a “grout”. These lines are optionally matte finished to give a low-gloss grout look. The embossing and corresponding color displacement may be non-linear, with higher levels of variegation and uneven in both depth and width. This will simulate the appearance of mortar for a brick and stone appearance to be used around fireplaces and foundation trim, etc.

Alternatively, an indexing process may be used to align the embossing and a visual effect in the panel. For example, the panel may be printed with special-effect colors and/or patterns; these patterns may be indexed to line up and visually correlate to a subsequent embossing pattern of brick, stone, or tile.

A further interlying stratum optionally has a photographic pattern of brick, stone, or other appearance. A further surface coating may have a non-smooth texture to simulate grit or sand of mortar or a rough stone face. This inventive panel variant is especially useful to allow retail stores to sell a product margin containing not only tile and stone materials but a component of the installation labor as well. The panel in a typical tub shower installation starts with drywall board surrounding the tub area as in any other installation. The preformed tile board of the inventive panel is cut along the inside corner edges of the installation and trimmed to size. The panels are adhered to the drywall and the corners and exposed edges are sealed with a sealant, such as caulk. Typical panel sizes are 3 feet×5 feet or 5 feet×5 feet. A further variant would be a kit of four equal size panels 5 feet tall by approximately 2 feet 7 inches to 3 feet wide and a 1 foot to 6 inches wide by 5 foot tall section. This section may have a soap and/or shampoo shelf embossed therein.

It is appreciated that any of the inventive panels herein may have a further coating applied thereon. The inventive coating is a mixture of polymers and/ or a selection of at least one of the following: glass, mineral, sand, silica, alumina, metal; especially nanometer sized domains of silica, mica, other minerals and other nanosize particulates. It may further include a coarse-grade pigment as described in the inventor's prior application. The coating is contacted with a building panel or accoutrement to alter the appearance of the panel to simulate metal, solid surface or glass. The coating may have sufficient leveling or flow agents such that it provides a smooth surface or it may have sufficient viscosity and/or solid content that it will not fully level and flow to a smooth appearance, thereby creating a matte or “sandy” finished appearance of the article that is coated.

A laminate structure of substantially thin dimension with upper layers of substantially translucent and/or clear optical nature can be used to contain granules of any variety. Granule as used herein is mean to describe discrete islands of material. These granules are typically visually differentiable from one another and may contain more than one color per granule. The granules may be typical prior art type of crushed polygonal thermoset or thermoplastic or combination resin, or they may be substantially flattened with an aspect ratio greater than 1.2 and preferably greater than 2.0. The laminate panel may have a substantially opaque rearward stratum with a visually differentiable pattern therein. The pattern may be printed, cast within the resin or embossed or colored by other means. This pattern may preferably simulate a strata layer of granules itself and need only be approximately 1 to 5 mils in total thickness, thereby representing a further efficiency in overall thickness of the panel. The patterned strata layer may also have a veined or marbleized or other visually differentiable pattern thereon.

As used herein granular particulate size is measured by averaging the x-y-z axial extent of particles and determining a mean average x-y-z linear dimension for the particulate sample. In the case of spherical granular particulate, x-y-z axes are equivalent and the mean linear dimension corresponds to the diameter of the domain. In the case of a high aspect ratio granule, the x-y dimension is averaged and compared to the z dimension to yield an overall aspect ratio.

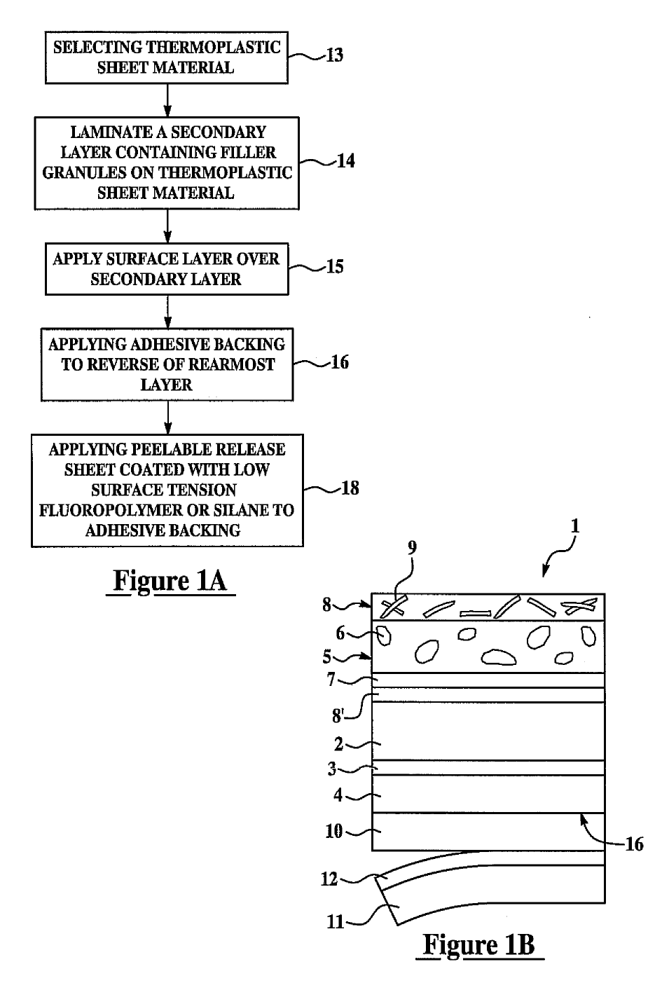

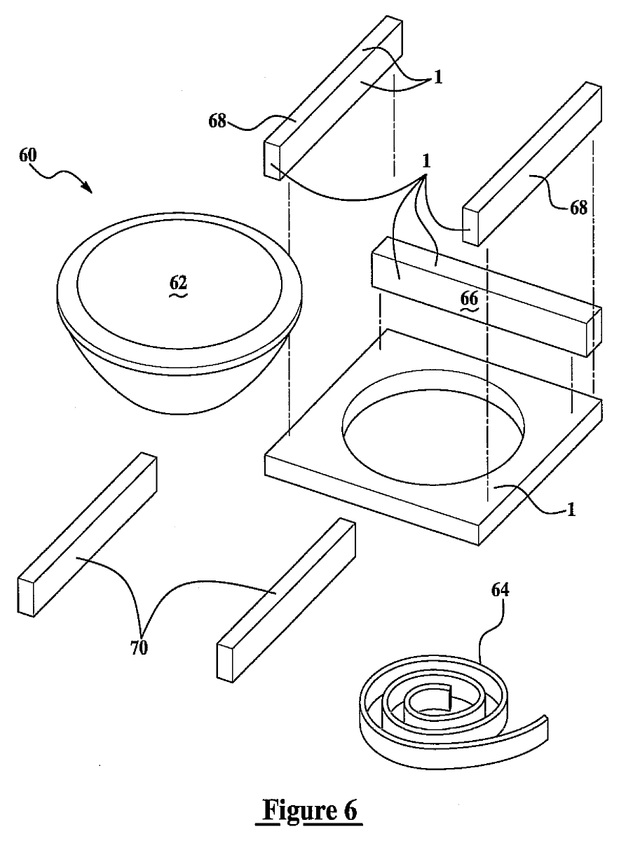

Referring now to FIGS. 1A and 1B, a process for forming a structural laminate is shown in FIG. 1A. The structural laminate is shown generally at 1 in FIG. 1B, where relative dimensions of layers are distorted for visual clarity. By selecting a thermoplastic sheet material at step 13, the formation begins, the thermoplastic sheet material 2 typically having a thickness between 0.003 and 0.25 inches. Preferably, the thermoplastic sheet material has a thickness between 0.010 and 0.035 inches. The sheet 2 is formed of a material illustratively including polyacrylate, polyamide, polyester, polysulfone, polycarbonate, polystyrene, polyurethane, polyvinylchloride, polyethylene, polypropylene, ABS, other polyolefins, thermoplastic rubbers illustratively including chloroprene, nitrile, and styrene-butadiene. The thermoplastic sheet material 2 is formed as a layer. The thermoplastic sheet material is chosen to be uniformly colored and opaque or translucent, or alternatively is transparent and includes an opaque backing layer 3. Preferably, the opaque backing layer 3 has a visually differentiable pattern relative to the overlying layers. It is appreciated that an opaque backing layer 3 as detailed herein is operative with any embodiments of inventive structural laminates detailed herein. In order to create a perception of depth within a transparent or translucent inventive structural laminate, an opaque backing layer 3 is printed with a variety of patterns that are at least in part visualized through an inventive structural laminate. Reflectiveness is enhanced by using a metal foil as a backing layer with an optional reverse reinforcement thermoplastic layer 4. For example, a spotted pattern mimics an added layer of granules placed in a regular pattern and preferably having a size slightly smaller than granular particulate within overlying layers adds to a perception of visual depth in the resulting structural laminate. Preferably, the spotted pattern includes variations in color and shading to further enhance the notion of perspective. Alternatively, a shading pattern uses shaded transition from lighter to darker hues of the same or different color to create a perception of visual depth. With a monochrome hue variation, an appearance results corresponding to thicker and thinner portions of colored glass while a polychromic lighter to darker shaded transition yields a marble-like appearance. Additionally, a variety of geometric patterns are readily printed on an outward facing surface of an opaque backing layer 3, such patterns including triangles, logos, geometric shapes and the like. Exemplary spotted, shading and geometric patterns are provided in FIG. 5.

The thermoplastic material 2, defined as including at least 51% thermoplastic by weight, is overlaid and laminated to a secondary layer 5 inclusive of filler granules 6, or other special-effect pigment. It is appreciated that when the secondary layer is a thermoplastic, the secondary layer amenable to thermal adhesion or a conventional welding process such as sonic or solvent, an intermediate adhesive layer is applied between the thermoplastic sheet material and the secondary layer. When a 100% thermoset material, it is appreciated that the secondary layer 5 is not amenable to coextrusion formation unless the cross-linking occurs during or after the extrusion process and therefore may be adhered to the thermoplastic sheet material 2 through contact cure, or the placement of a conventional adhesive 7 between the pre-cured thermoset layer 5 and the thermoplastic sheet material layer 2 at a later time. The secondary layer 5 laminated to the thermoplastic layer 2 at step 14 incorporates granular particulate 6 having at least 10% of the particles with an aspect ratio of greater than 2 and the secondary layer 5 is generally optically clear to allow the visual detection of the particulate therein.

It is appreciated that various additives are readily incorporated into an inventive laminate. These additives illustratively include a biocide, thickener, ultraviolet light protectorant, a hardener, a dye, an antistatic agent and combinations thereof.

As used herein, “aspect ratio” is defined as the ratio of linear dimension within a domain of the longest linear dimension relative to the shortest linear dimension orthogonal to the longest linear dimension. Preferably, the granules have a mean aspect ratio of greater than 1.2. More preferably, the mean aspect ratio is greater than 8 and the granule is discoid in shape.

Suitable granules operative herein illustratively include mica, cellulosic chips, shredded plastic film, silaceous materials, montmorillonite clays, graphite, aluminum trihydrate, metal flake and sintered glass shards. It is appreciated that inorganic granular particulate operates to not only reduce the thermal expansion associated with a polymeric matrix, but also conveys to a viewer a perception simulative of natural materials. Preferably, the particulate is inorganic. Additionally, it is appreciated that anisotropic particulate have a degree of surface roughness which enhances the perception of visual depth of the resulting inventive laminate, as compared to smooth spheroidal particulate.

The term “clear” as used with reference to the secondary layer indicates an optical transmissivity at 540 nanometers of greater than 70% for a secondary layer devoid of granular particulate and has a thickness of 0.1 inches. The granular particulate 6 is dispersed homogeneously throughout the secondary layer or forms a density gradient within the secondary layer orthogonal or parallel to a secondary layer planar surface. In the instance where the secondary layer 5 is a thermoplastic, it is appreciated that the granular particulate 6 is further aligned by elongating the secondary layer 5 in the plane of the sheet after particulate dispersion to selectively align the particulate in that direction. In the instance where the secondary layer 5 is a thermoset resin, a slurry of 3-45% by weight granular particulate is applied in concert with the secondary layer resin through conventional techniques illustratively including spraying, curtain walling and screeding. Preferably, at least 10% by weight of the granulate particulate is sized less than US 60 mesh.

It is appreciated that through control of the flexural modulus of the thermoplastic sheet material and the secondary layer, the resulting structural laminate has a controllable resiliency and bendability. Optionally, to modify the surface hardness of the structural laminate or modify the visual effect, a surface layer 8 is applied over the secondary layer 5 at step 15. A clear surface layer 8 optionally inclusive of granulate particulate 9 different from the granular particulate 6 within the secondary layer 5 serves to enhance the visual perception of depth. Preferably, the layer 8 has a hardness greater than that of secondary layer 5 so as to afford a measure of scratch resistance. Polyacrylates or clear grades of polycarbonate are particularly well suited for this application. It is appreciated that the translucency of the surface layer 8 or the secondary layer 5 is controlled by matching the index of optical refraction between a resin making up a layer and the granular particulate therein. Optionally, one or more intermediate clear coat transparent layers 8 devoid of particulate, but optionally including a photographic image printed thereon, are interspersed between layers 2 and 5 to visually offset the layers 2 and 5. The layer 8′ is thinner than adjacent layer 5. Additionally, it is appreciated that multiple stacks of layers 2 and 5 are successively laminated to build a more complex structure, with the appreciation that multiple layer laminates tend to increase the rigidity of the inventive laminate. Preferably, the index of refraction is matched between a layer resin and a layer granular particulate to less than 0.4.

Optionally, applying an adhesive backing 10 to the reverse of the rearmost layer of laminate 1 at step 16 is performed such that contact between the adhesive backing and a substrate will selectively adhere the structural laminate to the substrate. A rearmost layer is formed from materials including glass, thermoplastic, regenerated cellulose or metal. A thermoplastic rearmost layer preferably includes at least 15 weight percent EVA (ethyl vinyl acetate) resin. In instances where an adhesive backing 10 is applied at step 16, a peelable release sheet 11 coated with a low surface tension fluoropolymer or silane 12 is applied over the adhesive backing at step 18 to protect the adhesive backing 10 from premature adhesion and thereby facilitate stacking structural laminates and handling remote from the substrate. It is further appreciated that an inventive structural laminate 1 is pre-bonded to a substrate and in turn is adhered to a substructure such as plywood.

It is appreciated that an inventive laminate is also formed as detailed in FIG. 1B with the omission of thermoplastic sheet material layer 2. Optionally, surface layer 8 need not be present and the layer 5 laminated to a backing layer 3.

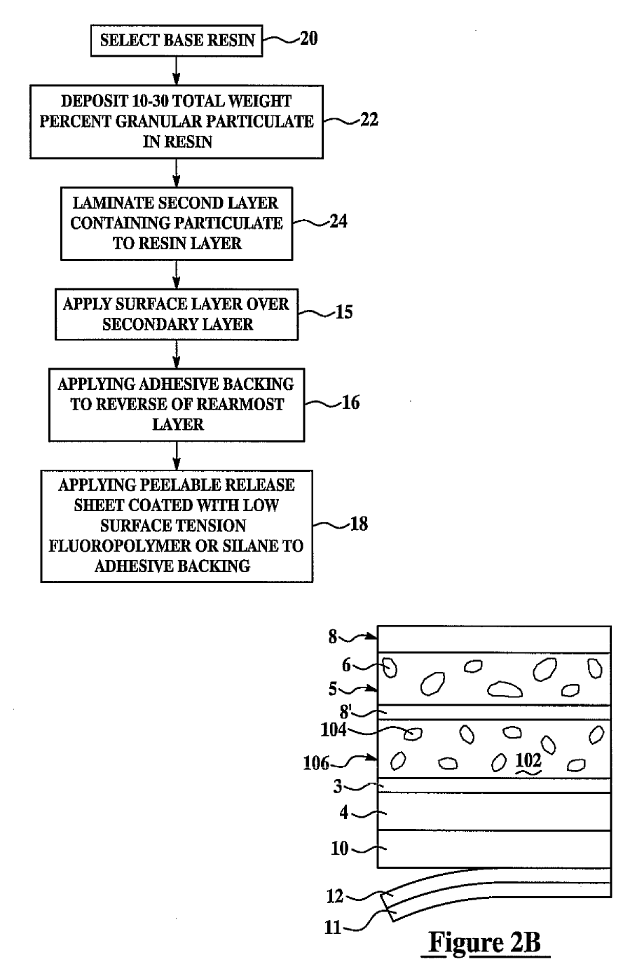

Another inventive structural laminate is detailed with respect to FIGS. 2A and 2B where like numerals correspond to those detailed with respect to FIGS. 1A and 1B, respectively. A base resin 102 is selected for the formation of a layer in step 20, the base resin 102 being either a thermoplastic or a thermoset resin. Between 7 and 35 total weight percent of a granular particulate 104 is deposited in the selected resin in step 22, with the identity of the granular particulate and the amount thereof being selected to reduce the coefficient of linear thermal expansion of the resulting resin by at least 25%. Preferably, at least 5 particle number percent of the granular particulate has an index of refraction that deviates from that of the base resin by less than 0.3. More preferably, the granulated particulate has a mean size of between 0.004 and 0.2 inches. Optionally, the base resin 102 containing the granular particulate 104 is laminated to a secondary layer 5 containing a greater amount of granular particulate 6 than the base resin 102 at step 24. In a particular embodiment, the particulate has a mean aspect ratio of greater than 1.2. Preferably, a number majority of the particulate having a long axis of greater than 0.03 inches is aligned with the particle long axis parallel to the embedding layer surface. Preferably, the secondary layer is rearmost relative to the viewer. In the instance where a secondary layer 5 containing a greater amount of granular particulate 6 is laminated at step 24 to a layer 106 formed from the base resin 102 in which 2-30% by weight granular particulate 104 has been deposited, the difference in coefficient of linear thermal expansion between the two layers is less than 50%. The base resin 102 is at least 51 weight percent thermoplastic. Preferably, the differential coefficient of linear thermal expansion is less than 25%. It is appreciated that a surface layer 8 is optionally applied over the secondary layer 5 as detailed at step 15 with or without particulate 9 therein of FIG. 1A. An adhesive backing 10 is optionally applied to the reverse of the layer 106 as detailed at step 16 of FIG. 1A. Preferably, a peelable release sheet 12 with a low surface tension film 11 is applied over the adhesive backing 10 to facilitate handling and transport per step 18.

A specific structural laminate produced according to the present invention has a base layer 106 that is translucent and a secondary layer 5 such that the secondary layer 5 has greater translucent permittivity to visible light than does the layer 106. Preferably, the coefficients of linear thermal expansion between the layers 5 and 106 are matched to within 60% of one another. The layer 106 in this exemplary form has uniform coloration as viewed from above the surface thereof contiguous with secondary layer 5. The secondary layer 5 is ideally color matched to within several shades of the layer 106. In order to provide a perception of greater depth to the resultant laminate, preferably the mean granular particulate size in secondary layer 5 is greater than that in the layer 106. In an extreme case, the layer 106 is devoid of particulate. Additional visually deceptive techniques to enhance depth perception include also modifying the density of particles per unit volume between the secondary layer 5 and the underlying layer 106. In a preferred form of particle density variation, smaller mean size and lower density per unit of surface area of granular particulate is deployed in the layer 106 relative to secondary layer 5. The visual deception of depth of an inventive laminate is further enhanced when the secondary layer 5 is at least 30% of the combined thickness of the layers 5 and 106. Preferably, a clear protective coating layer 8 is overlaid on secondary layer 5 so as to afford a measure of scratch resistance. A coextruded layer of polyacrylate is particularly well suited for this application, especially in those instances where layers 106 and 105 are coextruded.

Mica represents a particularly lustrous granular particulate. Preferably, one of the layers 5 or 106 includes at least 5% by weight mica. More preferably, the mica mean particle size and density per unit of surface area in projection through the volume of a layer decreases from the secondary layer 5 to the layer 106. In instances where the granular particulate includes mineral flour in at least one of the layers 5 or 106, the mineral flour is present in an amount of at least 5 total weight percent of the given layer with a mean particle size of less than 0.002 inches.

In a preferred embodiment, a structural laminate formed according to the present invention is engineered with recognition of the resultant physical properties to provide a durable and readily transported and applied substance. A structural laminate according to the present invention to this end includes a decorative plastic sheet having a thickness from 0.015 to 0.35 inches and an overall composition includes at least 60 total weight percent plastic resin and at least 10 weight percent of the plastic resin being thermoplastic. The decorative sheet within the structural laminate has a coefficient of linear thermal expansion of less than 7×10⁻⁵ per degrees Celsius, a flexural modulus of between 250,000 and 900,000 pounds per square inch, and a heat distortion temperature of at least 70° F. The structural laminate has at least one strata layer inclusive of granular particulate. The granular particulate is formed from a material having a particulate coefficient of linear thermal expansion that is less than that of the plastic resin cured in a pure state. As a result, the inclusion of granular particulate has the effect of reducing the coefficient of linear thermal expansion of the structural laminate relative to the plastic resin component. Optionally, the granular particulate has a mean aspect ratio of greater than 1.2. In the course of drawing a thermoplastic sheet, preferably a number majority of the particulate having a long axis of greater than 0.03 inches is aligned with the particle long axis parallel to the surface of the structural laminate. In order to reduce the thermal expansion of the plastic resin, in a particular embodiment of the present invention the granular particulate introduced therein is a majority by weight of thermoset resin or mineral, with the granular particulate resin identity chosen ideally to be different than that of the plastic resin matrix. Optionally, the granular particulate present in the at least one strata layer is present at a loading level such that traversing the at least one strata layer at 0.090″ thickness contacts at least one particle of the granular particulate. It is appreciated that granular particulate having an irregular as opposed to a smooth surface is readily used herein as well. A granular particulate particularly well suited for use in a structural laminate includes mica and a polymer of biological origin such as cellulosic material denoted herein as a biopolymer. Such biopolymers are considered here to be thermoplastic, though they can be heavily cross-linked. The structural laminate optionally includes a rearmost layer. A rearmost layer, if present, is preferably opaque. A rearmost layer, if present, preferably includes at least 15 weight percent EVA (ethyl vinyl acetate) resin or other additive to create a surface activity above 32 dyne. Optionally, an adhesive backing is applied to the rearmost layer of the laminate and preferably a peelable release sheet coated with a low surface tension fluoropolymer or silane is applied over the adhesive back to protect the adhesive backing from premature adhesion so as to facilitate stacking structural laminates and handling remote from the ultimate application substrate.

A thermoplastic strata layer of an inventive structural laminate imparting particularly attractive properties to the resultant structural laminate includes at least 40% by weight thermoplastic resin and granules made up of at least 10% by weight mineral within the resin. The granules have a size distribution including the largest 10 number percent embedded within the resin such that the largest 10% of the size distribution is less than 6 millimeters in mean x-y-z dimension average linear dimension with the thermoplastic strata layer having a thickness of between 0.015 and 0.35 inches.

In another exemplary form, an inventive structural laminate particulate granules have a mean aspect ratio greater than 0.8 and less than 1.3 with 20 by number percent of particulate granules having the largest mean size have the longest linear dimension that is equal to or less than half the thickness of the layer in which the granular particulate is embedded. An ideal source of such granular particulate to provide a high degree of luster is smashed filler polymer ingot that has been ground to a given particulate size and the resulting particulate smashed to provide anisotropic particulate. Preferably such ingot would be filled with mineral or wood-based fillers such as hydrated alumina, silaceous materials, calcium carbonate, wood, wood pulp, wood flour, and further preferably would contain at least 10% by weight a thermoset resin component such as derived from a biopolymer or more traditional thermoset resin such as unsaturated polyester resin. Preferably, a number majority of the granular particulate having a long axis of greater than 0.03 inches is aligned with the particle long axis parallel to a surface of the layer in which it is embedded.

A process is provided to produce thermoplastic pellets preloaded with granular particulate. According to this process, a thermoplastic resin is heated to a temperature at which the plastic resin becomes a viscous liquid. As is conventional to the art, the atmosphere above the liquid thermoplastic is optionally modified to an inert gas or vacuum. Into the liquid thermoplastic granular particulate is intermixed wherein at least 2% by weight of the granular particulate has a mean dimension averaged over three orthogonal directions of at least 0.008 inches. The granular particulate is introduced into the liquid thermoplastic at a point downstream of the mouth of a screw and barrel assembly. The resulting granular particulate containing thermoplastic is cooled and divided into pellets. The resultant pellets are particularly well suited to be fed into a sheet extruder for the production of the granular particulate layer of an inventive structural laminate. Preferably, a layer formed by extruding granular particulate laden pellets has a thickness between 0.01 and 0.05 inches. More preferably, the thermoplastic melt is loaded with granular particulate to a level where a 0.120 inch thick melt is traversed by contacting at least one particle of the granular particulate. The identity of the thermoplastic materials and the granular particulates are those previously mentioned with respect to FIGS. 1A and 1B. It is appreciated that the granular particulate optionally undergoes a change in a property during the course of processing, the property including size, shape, color or hue. Such particulate change is typically associated with a thermal activation and or mechainical agitation. Optionally, an extruder producing a layer of an inventive structural laminate is run with a breaker plate in a non-closed position yielding a continuous sheet amenable to collection on a roll mandrel.

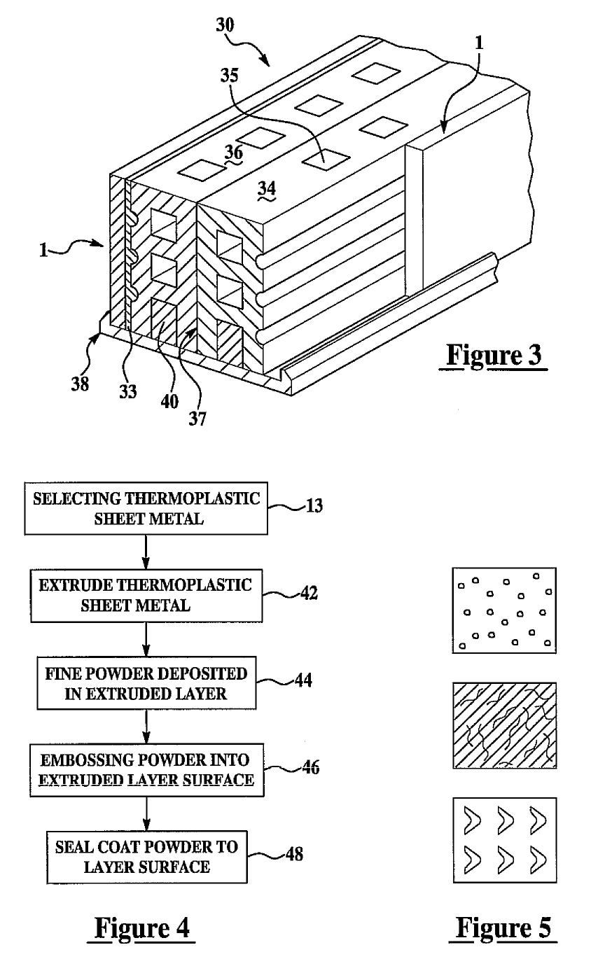

Referring now to FIG. 3, an edging system operative with an inventive structural laminate is depicted generally at 30 in FIG. 3. An inventive structural laminate 1 is adhered to a fluted panel substrate 34 through conventional techniques such as contact adhesive bonding with an adhesive 33. The fluted panel substrate 34 has a defined series of depressions 35 therein. An exemplary fluted panel is available from Parkland Plastics having square cross section channels running the length of the substrate under the trade name Plastex® waterproof wall panels. Optionally, a second structural laminate 36 is optionally adhered to the opposing surface 37 of the panel substrate 34 in order to form a material having two opposing face surfaces. A trim piece 38 is formed to seal the edges of the substrate panel and the adhered inventive structural laminate 1. The trim piece 38 has a series of complementary protuberances 40 adapted to engage the depressions 35 within the substrate panel 34.

The trim piece 38 is typically formed by injection molding and adhered to the substrate and at least one inventive structural laminate through corona treatment, contact adhesive or welding. It is appreciated that the trim piece 38 is also readily formed of other materials such as rubbers and metals. An inventive trim piece 38 can be formed with a variety of finishes ranging from gloss to matte or further include a track for insertion of a custom color insert or adhesion of a printed contact strip to provide additional visual presentations.

Referring now to FIG. 4, a process for forming another embodiment of an inventive structural laminate is provided where like numerals correspond to those detailed with respect to FIG. 1. A thermoplastic sheet material is selected 13. A thermoplastic sheet is then extruded at step 42. Preferably, the thermoplastic sheet is extruded from the preloaded pellets containing granular particulate as detailed above. Fine powder having a typical particle size of less than US 80 mesh is deposited onto the surface of the thermoplastic sheet layer 2 at step 44. The powder is then embossed into the thermoplastic sheet surface at step 46. Preferably, the embossing roller used to emboss the powder into the surface also imparts a textural pattern into the surface. Additionally, it is appreciated that a surface is embossed to create a pattern of depressions into which powder is preferentially deposited resulting in a settling of particulate granules into the sheet surface. The sheet surface having powder embossed therein is then sealed with a seal coat at step 48. The resulting seal coated sheet is then incorporated into an inventive structural laminate as any one of the layers 2, 3, 5, 8 or 106 of FIG. 1B or 2B, through completing the process steps of either FIG. 1A or 2A.

To seal powder into a surface as detailed in step 48 of FIG. 4, in one embodiment, the seal is created by the addition of an opaque backing layer.

A photographic image is readily applied to an opaque or transparent sheet and applied intermediate between layers 2 and 5, 5 and 8, or between layers 106 and 5 as detailed with respect to FIGS. 1B and 2B. It is appreciated that the photographic image intermediate between layers is necessarily transparent to provide visual perception through the underlying layer. The photographic image is also applied as an opaque backing layer that corresponds to layer 3 with respect to FIGS. 1B and 2B. According to the present invention such a photographic sheet is applied to a given layer prior to bonding to additional layers of the inventive structural laminate. This is in stark contrast to conventional methodologies where printing occurs subsequent to laminate bonding between adjacent layers.

Dramatic visual effects are obtained when a surface has a metallic sheen. It is appreciated that a granular particulate or powder is readily coated through electrodeposition resin entrapment, or adhesion of metal, or metallic-appearing powder thereto. The resulting metal coated granular particulate or powder is readily introduced into an inventive structural laminate. Metals suitable for deposition or powder adhesion to an underlying granular particulate include copper, zinc, silver, gold, platinum, bronze, iron, titanium, as well as the oxides of each of the aforementioned metals.

An advantage of an inventive structural laminate is that a veneer having a thickness of from 0.01-0.05 inches in thickness can be pre-bonded to a substrate allowing for a vanity sink top kit to be provided that is considerably lighter and covers a smaller volume than a conventional integral top bowl vanity surface. An exemplary kit is shown generally at 60 in FIG. 6. An inventive structural laminate 1 per FIG. 1A including the finish veneer and a substrate is used to form the deck of a vanity countertop. A preformed bowl 62, edge banding 64 and various rectilinear pieces that form the back 66 and the side splashes 68 and optionally structural support pieces 70 for the bowl 62 are also provided. The various components are readily assembled through snap fittings, sonic welding and/or glue. It is appreciated that tongue-and-groove type alignment channels facilitate installation of the components.

Any patents or publications mentioned in the specification are incorporated herein by reference to the same extent as if each individual patent or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A process for forming a thermoplastic sheet layer containing granular particulate comprising:
raising the temperature of a thermoplastic to form a melt;
passing said melt through a mouth of a screw and barrel assembly;
loading said melt with granular particulate to a load level where a 0.90 inch thick melt is traversed by contacting at least one particle of said granular particulate, said particulate having at least 2% by weight being particles with a mean x-y-z dimension averaged linear dimension of greater than 0.008 inches to yield a pigmented melt;
cooling said pigmented melt;
forming pellets from said pigmented melt; and
extruding the thermoplastic sheet layer from said pellets.

2. The process of claim 1 wherein said sheet has a thickness of between 0.01 and 0.07 inches.

3. The process of claim 1 where said sheet is extruded from an extruder operating with the breaker plate in a non-closed position.

4. The process of claim 1 further comprising:
depositing a second granular particulate on a surface of said sheet layer;
embossing said second granular particulate into said sheet; and
sealing said second granular particulate into the surface.

5. The process of claim 4 wherein sealing is performed with an opaque backing sheet.

6. The process of claim 4 wherein the opaque backing sheet has a discernable pattern.

7. The process of claim 4 further comprising overlayering the surface with a secondary layer.

8. The process of claim 7 wherein said secondary layer is selected from a group consisting of: a thermoplastic, a thermoset, glass, and metal.

9. The process of claim 8 wherein said secondary layer is a thermoset that cross-links during the step of extruding.

10. The process of claim 7 wherein said secondary layer is selcted from a group The process of claim 7 wherein said secondary layer is selected from one of the following: a thermoplastic, thermoset resin, glass, and metal.

11. The process of claim 7 wherein said secondary layer further comprises granular particulate therein.

12. The process of claim 1 wherein said granular particulate undergoes a change in a property selected from the group consisting of: size, shape, color, and hue:

13. A process for forming a structural laminate comprising:
securing a photographic image backing to a transparent or translucent layer;
bonding said layer to at least one additional layer to yield the structural laminate.

14. A structural laminate having a width and length and a thickness, said thickness being from 0.015 to 0.350 inches, an overall composition of at least 60 total weight percent plastic resin, and at least 10 weight percent of said plastic resin being a thermoplastic, said sheet having a coefficient of linear thermal expansion of less than 7×10⁻⁵/° C., a flexural modulus of between 250,000 and 900,000 pounds per square inch, a heat distortion temperature of at least 170° F., and at least one strata layer inclusive of granular particulate wherein said granular particulate is formed from a material having a particulate that is less than that of said plastic resin in a pure cured state.

15. The laminate of claim 12 wherein said granular particulate has a mean aspect ratio of greater than 1.2.

16. The laminate of claim 13 wherein a number majority of particulate having a long axis greater than 0.03 inches is aligned with a particle long axis parallel to a surface of said layer.

17. The laminate of claim 12 wherein said material of said granular particulate is a majority by weight thermoset resin.

18. The laminate of claim 12 wherein said material of said granular particulate is a majority by weight mineral.

19. The laminate of claim 12 wherein said granular particulate is present in the at least one strata layer at a level such that traversing the at least one strata layer contacts at least one particle of said granular particulate.

20. The laminate of claim 12 wherein said granular particulate has an irregular shape.

21. The laminate of claim 12 wherein said granular particulate is of a size distribution such that at least 80% of individual granules are not visible to the unaided eye and appear to be of one color.

22. The laminate of claim 13 wherein said material of which said granular particulate is formed is selected from a group consisting of: mica and a biopolymer.

23. The laminate of claim 12 further comprising a rearmost layer.

24. The laminate of claim 20 wherein the rearmost layer is opaque.

25. The laminate of claim 21 wherein the rearmost layer is at least 15 weight percent ethyl vinyl acetate resin.

26. The laminate of claim 20 further comprising an adhesive backing applied to a reverse surface of the rear layer.

27. A thermoplastic strata layer of a structural laminate comprising at least 40% by weight thermoplastic resin, granules comprising at least 10% by weight mineral within said resin, said granules having a size distribution including a largest 10 number percent, wherein the largest 10 number percent of the size distribution is less than 6 millimeters mean x-y-z averaged linear dimension, and the layer has a thickness of between 0.015 and 0.35 inches.

28. The layer of claim 24 wherein said thermoplastic resin is selected from a group consisting of: polyacrylate, polyamide, polyester, polysulfone, polycarbonate, polystyrene, polyurethane, polyvinylchloride, polyethylene, polypropylene and ABS.
